(19) United States
(12) Patent Application Publication
(10) Pub. No.: US 2025/0149660 A1
(43) Pub. Date: May 8, 2025

(54) Devices and Methods for Improving Proximate Device Battery Management

(71) Applicant: ZEBRA TECHNOLOGIES CORPORATION, Lincolnshire, IL (US)

(72) Inventors: Mariya Wright, Cortland Manor, NY (US); Kenneth S. Bhella, Stony Brook, NY (US)

(21) Appl. No.: 18/387,835

(22) Filed: Nov. 7, 2023

(51) Int. Cl. H01M 10/42; H02J 7/00

(52) U.S. Cl. CPC H01M 10/4257; H02J 7/00043; H02J 7/0048; H01M 2010/4271; H01M 2010/4278

(57) ABSTRACT

Devices and methods for improving proximate device battery management are disclosed herein. An example method includes receiving a signal from a proximate device when the proximate device satisfies a distance threshold. The signal may include a dataset corresponding to the proximate device, and the proximate device may have a primary connection to a primary device. The example method may further include analyzing the dataset to determine whether a battery management threshold of the proximate device is violated; and in response to determining that the battery management threshold is violated, establishing a secondary connection to the proximate device.

### BACKGROUND

Modern scanning devices bring convenience, flexibility, and maneuverability to data capture workflows. These handheld scanning devices typically benefit from robust remote control/management capabilities. However, conventional techniques for controlling and/or managing such scanning devices remotely have various limitations. Accordingly, there is a need for devices and methods to quickly and efficiently control and manage scanning devices remotely, and thereby reduce/eliminate the impact of these limitations.

### SUMMARY

In an embodiment, the present invention is a device for improving proximate device battery management. The device may comprise: one or more processors; and one or more memories storing instructions thereon that, when executed by the one or more processors, are configured to cause the device to: receive a signal from a proximate device when the proximate device satisfies a distance threshold, the signal including a dataset corresponding to the proximate device, and the proximate device having a primary connection to a primary device, analyze the dataset to determine whether a battery management threshold of the proximate device is violated, and in response to determining that the battery management threshold is violated, establish a secondary connection to the proximate device.

In a variation of this embodiment, the instructions, when executed by the one or more processors, may further cause the device to: transmit a control instruction to the proximate device across the secondary connection to generate an alert at the proximate device associated with violating the battery management threshold.

In another variation of this embodiment, the battery management threshold may include one or more of: (i) a remaining battery charge threshold of the proximate device, (ii) a charging time threshold of the proximate device, and (iii) a charging placement threshold of the proximate device.

In yet another variation of this embodiment, the secondary connection may comprise an instant direct connection to the proximate device via a Bluetooth Low Energy (BLE) protocol.

In still another variation of this embodiment, the instructions, when executed by the one or more processors, may further cause the device to: determine that a time threshold has been exceeded; receive a plurality of signals from a plurality of proximate devices when each respective proximate device satisfies the distance threshold, each respective signal of the plurality of signals including a respective dataset corresponding to the respective proximate device; analyze each respective dataset to determine a set of proximate devices from the plurality of proximate devices that violate the battery management threshold; substantially simultaneously establish a respective secondary connection to each proximate device of the set of proximate devices; and transmit a control instruction to each proximate device of the set of proximate devices across the respective secondary connections to generate an alert at each proximate device of the set of proximate devices.

In yet another variation of this embodiment, the signal may be a BLE signal transmitted by the proximate device as a periodic beacon.

In still another variation of this embodiment, the proximate device may be configured to transmit a first dataset across the primary connection to the primary device, and at least a portion of the first dataset may not be included in the signal transmitted from the proximate device.

In another embodiment, the present invention is a computer-implemented method for improving proximate device battery management. The method may comprise: receiving a signal from a proximate device when the proximate device satisfies a distance threshold, the signal including a dataset corresponding to the proximate device, and the proximate device having a primary connection to a primary device; analyzing the dataset to determine whether a battery management threshold of the proximate device is violated; and in response to determining that the battery management threshold is violated, establishing a secondary connection to the proximate device.

In a variation of this embodiment, the method may further comprise: transmitting a control instruction to the proximate device across the secondary connection to generate an alert at the proximate device associated with violating the battery management threshold.

In another variation of this embodiment, the battery management threshold may include one or more of: (i) a remaining battery charge threshold of the proximate device, (ii) a charging time threshold of the proximate device, and (iii) a charging placement threshold of the proximate device.

In yet another variation of this embodiment, the secondary connection may comprise an instant direct connection to the proximate device via a BLE protocol.

In still another variation of this embodiment, the method may further comprise: determining that a time threshold has been exceeded; receiving a plurality of signals from a plurality of proximate devices when each respective proximate device satisfies the distance threshold, each respective signal of the plurality of signals including a respective dataset corresponding to the respective proximate device; analyzing each respective dataset to determine a set of proximate devices from the plurality of proximate devices that violate the battery management threshold; substantially simultaneously establishing a respective secondary connection to each proximate device of the set of proximate devices; and transmitting a control instruction to each proximate device of the set of proximate devices across the respective secondary connections to generate an alert at each proximate device of the set of proximate devices.

In yet another variation of this embodiment, the signal may be a BLE signal transmitted by the proximate device as a periodic beacon, the proximate device may be configured to transmit a first dataset across the primary connection to the primary device, and at least a portion of the first dataset may not be included in the signal transmitted from the proximate device.

In yet another embodiment, the present invention is a tangible machine-readable medium comprising instructions for improving proximate device battery management that, when executed, cause a machine to at least: receive a signal from a proximate device when the proximate device satisfies a distance threshold, the signal including a dataset corresponding to the proximate device, and the proximate device having a primary connection to a primary device; analyze the dataset to determine whether a battery management threshold of the proximate device is violated; and in response to determining that the battery management threshold is violated, establish a secondary connection to the proximate device.

In a variation of this embodiment, the instructions, when executed, may further cause the machine to at least: transmit a control instruction to the proximate device across the secondary connection to generate an alert at the proximate device associated with violating the battery management threshold.

In another variation of this embodiment, the battery management threshold may include one or more of: (i) a remaining battery charge threshold of the proximate device, (ii) a charging time threshold of the proximate device, and (iii) a charging placement threshold of the proximate device.

In yet another variation of this embodiment, the secondary connection may comprise an instant direct connection to the proximate device via a BLE protocol.

In still another variation of this embodiment, the instructions, when executed, may further cause the machine to at least: determine that a time threshold has been exceeded; receive a plurality of signals from a plurality of proximate devices when each respective proximate device satisfies the distance threshold, each respective signal of the plurality of signals including a respective dataset corresponding to the respective proximate device; analyze each respective dataset to determine a set of proximate devices from the plurality of proximate devices that violate the battery management threshold; substantially simultaneously establish a respective secondary connection to each proximate device of the set of proximate devices; and transmit a control instruction to each proximate device of the set of proximate devices across the respective secondary connections to generate an alert at each proximate device of the set of proximate devices.

In yet another variation of this embodiment, the signal may be a BLE signal transmitted by the proximate device as a periodic beacon.

In still another variation of this embodiment, the proximate device may be configured to transmit a first dataset across the primary connection to the primary device, and at least a portion of the first dataset may not be included in the signal transmitted from the proximate device.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1A depicts an example scanning device, primary device, and a secondary device configured to establish a secondary connection with the example scanning device, in accordance with embodiments described herein.

FIG. 1B depicts a plurality of example scanning devices and a secondary device configured to establish secondary connections with each example scanning device that is proximate to the secondary device, in accordance with embodiments described herein.

FIG. 2 is a block diagram of an example logic circuit for implementing example methods and/or operations described herein.

FIGS. 3A and 3B are flowcharts representative of various methods for improving proximate device battery management, in accordance with embodiments described herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

As previously mentioned, conventional techniques for controlling and/or otherwise managing handheld scanning devices suffer from several issues. For example, conventional remote control and/or device management techniques typically require the handheld scanning device be connected to a wired host device, such as a charging cradle or workstation. If the scanning device lacks such a connection the wired host device, the handheld scanning devices may be invisible to the conventional control systems, preventing remote control or monitoring. Further, communications between the handheld scanning device and wired host device frequently rely on polling the handheld scanning device, which can overburden the host device and thereby degrade the host device's performance when processing control instructions simultaneously with other data received from the handheld scanning device.

Thus, it is an objective of the present disclosure to eliminate these and other problems with such conventional techniques by providing devices and methods for improved proximate device battery management. The devices and methods of the present disclosure may ensure that scanning devices receive adequate processing bandwidth for all functionality (e.g., remote management/control, data decoding, etc.), such that each scanning device may be more reliably managed and controlled and host devices are not overburdened. In this manner, the devices and methods of the present disclosure may provide more reliable and effective remote device control and management than conventional techniques, and may reduce host latency issues experienced in conventional systems by siphoning device management/control functions to secondary devices.

In accordance with the above, and with the disclosure herein, the present disclosure includes improvements in computer functionality or in improvements to other technologies at least because the present disclosure describes that, e.g., device control systems, and their related various components, may be improved or enhanced with the disclosed methods and systems that provide accurate, reliable, and efficient remote device control for respective users and administrators. That is, the present disclosure describes improvements in the functioning of a device control system itself or “any other technology or technical field” (e.g., the field of device control/management systems) because the disclosed methods and devices improve and enhance operation of device control/management systems by introducing improved device connection and data transmission techniques that reduce and/or eliminate many inefficiencies typically experienced over time by device control systems lacking such methods and devices. This improves the state of the art at least because such previous device control systems can be inefficient and unreliable due to issues associated with wired host connection requirements, communications via polling, and limited data processing/transmission bandwidth.

In addition, the present disclosure includes applying various features and functionality, as described herein, with, or by use of, a particular machine, e.g., a proximate device, a primary/secondary device, and/or other hardware components as described herein.

Moreover, the present disclosure includes specific features other than what is well-understood, routine, conventional activity in the field, or adding unconventional steps that demonstrate, in various embodiments, particular useful applications, e.g., receiving a signal from a proximate device when the proximate device satisfies a distance threshold, the signal including a dataset corresponding to the proximate device, and the proximate device having a primary connection to a primary device; analyzing the dataset to determine whether a battery management threshold of the proximate device is violated; and/or in response to determining that the battery management threshold is violated, establishing a secondary connection to the proximate device, among others.

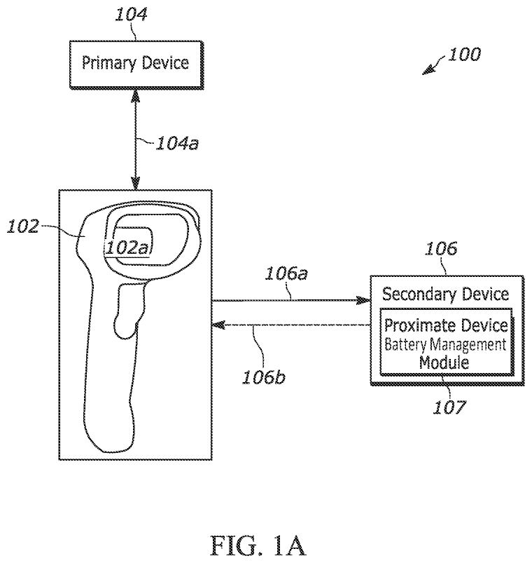

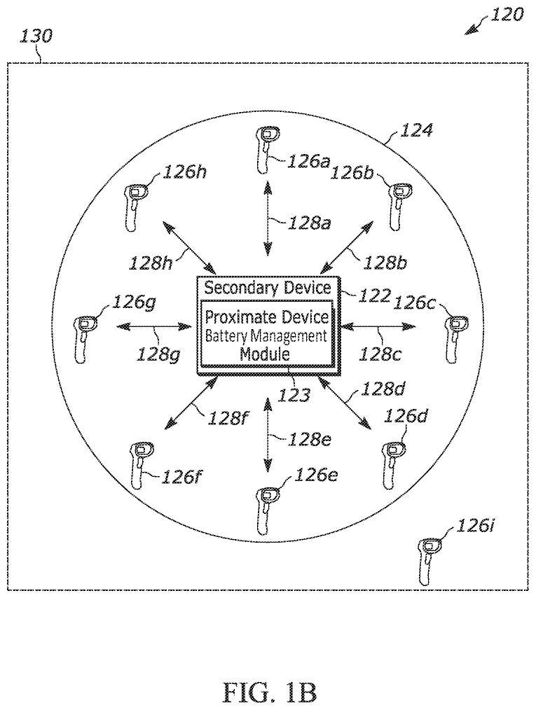

Turning to the Figures, FIG. 1A depicts an exemplary remote control/management scenario 100 including an example scanning device 102, a primary device 104, and a secondary device 106. The example scanning device 102 may be, for example, a handheld scanning device configured to capture image data of indicia (e.g., barcodes, quick response (QR) codes, etc.). In the exemplary remote control/management scenario 100, the example scanning device 102 may establish and/or otherwise maintain a primary connection 104a with the primary device 104. The example scanning device 102 may transmit data to the primary device 104, such as data including and/or related to captured indicia image data. The primary device 104 may receive the transmitted data from the example scanning device 102 and may perform various functions related to the transmitted data (e.g., retrieving product information related to the decoded indicia).

As part of this exemplary remote control/management scenario 100, the example scanning device 102 may periodically emit a beacon or other similar transmission (e.g., signal 106a) via beacon transmitter 102a that may be received by any proximate device (e.g., secondary device 106). The signal 106a may be, for example, a BLE beacon signal configured to transmit certain information corresponding to the example scanning device 102, such as remaining battery life, charging connection status, received signal strength indicator (RSSI) values, asset identification information, etc. In any event, the secondary device 106 may receive this signal 106a when the secondary device 106 is within the transmission range of the signal 106a, or “proximate”, transmitted from the example scanning device 102.

The secondary device 106 may receive the signal 106a, analyze the data contained in the signal 106a using the proximate device battery management module 107, and determine whether to establish a secondary connection 106b with the example scanning device 102. As mentioned, the signal 106a may include any suitable information about the example scanning device 102, and the secondary device 106 may utilize this information to determine whether the example scanning device 102 requires control outside of the communications facilitated by the primary connection 104a with the primary device 104. If the secondary device 106 determines that such control is required, then the secondary device 106 may establish a secondary connection 106b to the example scanning device 102 to transmit control instructions. The proximate device battery management module 107 may determine that control is required based on various thresholds corresponding to the information included in the signal 106a. The secondary device 106 may be a smartphone, cell phone, mobile computer, smart watch, smart glasses, and/or any other suitable device capable of receiving the signal 106a from the example scanning device 102.

As an example, the example scanning device 102 may communicate image data and/or data derived from such image data (e.g., indicia decode data) to the primary device 104 across the primary connection 104a, and the secondary device 106 may be within and/or come within the beaconing range of the example scanning device 102. While the example scanning device 102 maintains and/or actively transmits information/data across the primary connection 104a to the primary device 104, the beacon transmitter 102a may periodically emit the signal 106a as a beacon and/or in accordance with any other suitable communications protocol. In certain embodiments, the example scanning device 102 may transmit a first dataset across the primary connection 104a to the primary device 104, and at least a portion of the first dataset may not be included in the signal 106a transmitted/broadcast from the example scanning device 102. Regardless, the secondary device 106 may receive the signal 106a, analyze the dataset included as part of the signal 106a using the proximate device battery management module 107, and may determine that the battery of the example scanning device 102 requires charging.

Namely, the proximate device battery management module 107 may determine that the remaining battery charge percentage/value (e.g., 10%) indicated in the signal 106a is below a remaining battery charge threshold (e.g., 15%), so the secondary device 106 may determine that the scanning device 102 should be controlled to alert users that the device 102 should be charged soon. The secondary device 106 may establish a secondary connection 106b with the example scanning device 102, across which, the secondary device 106 may transmit a control instruction causing the example scanning device 102 to, for example, emit a noise, flash a light, provide haptic feedback, and/or any other suitable output that may alert a user that the example scanning device 102 requires charging.

In the prior example, the secondary device 106 establishes the secondary connection 106b with the example scanning device 102 to transmit the control instruction related to a low remaining battery charge. This example control instruction may not require substantial packet size and/or transmission channel bandwidth to transmit quickly to the example scanning device 102, such that the secondary connection 106b may be an instant direct connection to the example scanning device 102 via a BLE protocol that does not require pairing between the scanning device 102 and the secondary device 106. The proximate device battery management module 107 may utilize a similar instant direct connection 106b to transmit other control instructions to the scanning device 102.

As another example, the scanning device 102 may transmit a beacon signal 106a indicating that the scanning device 102 has violated/is violating a charging placement threshold. In particular, the beacon signal 106a may indicate that the scanning device 102 is connected to a charging cradle without charging, such that a user should inspect the scanning device 102 to ensure that the scanning device 102 is correctly placed in the charging cradle and/or that the scanning device 102 and/or the cradle are otherwise undamaged. The proximate device battery management module 107 may analyze the beacon signal 106a, determine that the charging placement threshold has been violated, and may establish the secondary connection 106b to the scanning device 102. The proximate device battery management module 107 may also transmit a control instruction to the scanning device 102 across the secondary connection 106b to generate an alert at the scanning device 102 associated with violating the charging placement threshold. For instance, the alert may be or include flashing lights, emitting audible sounds, providing haptic feedback, and/or any other suitable outputs or combinations thereof.

As yet another example, the scanning device 102 may transmit a beacon signal 106a indicating that the scanning device 102 has violated/is violating a charging time threshold. In particular, the beacon signal 106a may indicate that the scanning device 102 has not been charging for at least three hours, such that a user should connect the scanning device 102 to a charging cradle/station. The proximate device battery management module 107 may analyze the beacon signal 106a, determine that the charging time threshold has been violated, and may establish the secondary connection 106b to the scanning device 102. The proximate device battery management module 107 may also transmit a control instruction to the scanning device 102 across the secondary connection 106b to generate an alert at the scanning device 102 associated with violating the charging time threshold. For instance, the alert may be or include flashing lights, emitting audible sounds, providing haptic feedback, and/or any other suitable outputs or combinations thereof.

In this manner, the secondary device 106 and the proximate device battery management module 107 may alleviate the processing and bandwidth burdens on the primary device 104 by performing various functions across the secondary connection 106b that would otherwise occupy resources of the primary device 104 and/or primary connection 104a. For example, the secondary device 106 may control and/or manage the scanning device 102 by querying battery/charging information of the scanning device 102, activating a function of the scanning device 102, and/or any other suitable action(s) or combinations thereof.

FIG. 1B is an example environment 120, where techniques for improving proximate device control may be implemented, in accordance with embodiments described herein. The example environment 120 includes a secondary device 122 with a proximate device control module 123 and a proximity threshold 124, multiple scanning devices 126a-h with secondary connections 128a-h to the secondary device 122, and a scanning device 126i that is outside of the proximity threshold 124. The example scanning environment 100 may include a work environment 130, such as a warehouse, a retail store, a hospital, and/or any other suitable location where the multiple scanning devices 126a-i and the secondary device 122 may be located.

In certain embodiments, each scanning device 126a-i may be a wireless/cordless scanning device. For example, each scanning device 126a-i and the secondary device 122 may have integrated transceivers (not shown) and/or other suitable device(s) that enable the device 104a and the secondary device 122 to engage in two-way communications, as described herein. These two-way communications may be or include, for example, the secondary device 122 pairing with one or more of the scanning devices 126a-h as part of establishing a secondary connection 128a-h that accommodates large file transfers, such as a fast file transfer connection. Additionally, or alternatively, the two-way communications may not include pairing (e.g., instant direct connect of secondary connection 106b) in instances when the secondary device 122 may transmit smaller files to control the scanning devices 126a-h.

Further, the secondary device 122 and the scanning devices 126a-i may have wireless signal transceivers (not shown) configured to transmit and/or receive beacon signals, such as BLE beaconing. This beaconing may be or include any of the scanning devices 126a-i broadcasting a BLE signal at regular/frequent intervals to allow the secondary device 122 and/or other nearby devices to determine proximity to and/or status of the scanning devices 126a-i. In particular, the BLE signal may be structured and/or adhere to any suitable protocol (e.g., iBeacon, Eddystone, AltBeacon), and the advertising packets comprising the BLE signal may include multiple user configurable fields. These user configurable fields may enable users to include specific values in the advertising packets that may inform any devices receiving the BLE signal in a manner desired by the user. For example, and as discussed herein, the user may configure the advertising packets to include indications corresponding to a remaining battery charge/level, a charging time, a charging placement, etc. of the scanning devices 126a-i at the time the BLE signal was transmitted. Moreover, it should be appreciated that any suitable type of beaconing, such as Bluetooth® Classic beaconing, Wi-fi Beaconing, active radio frequency identification (RFID) tags, flashing lights, audible tones, and/or combinations thereof may also be used.

In any event, the secondary device 122 may move through the work environment 130 (e.g., carried by a user) and may receive a plurality of signals from a plurality of proximate devices when each respective proximate device satisfies a distance threshold from the secondary device 122. As illustrated in FIG. 1B, each of the scanning devices 126a-h may be proximate to the secondary device 122, as each of the scanning devices 126a-h is within the proximity threshold 124 of the secondary device 122. In other words, each of the scanning devices 126a-h may be close enough to the secondary device 122, such that beacons emitted by the scanning devices 126a-h may be received at a receiver (not shown) of the secondary device 122. By contrast, the scanning device 126i may not be proximate to the secondary device 122, such that beacons emitted by the scanning device 126i may not be received by a receiver of the secondary device 122. The secondary device 122 may receive any suitable number of signals from any suitable number of proximate scanning devices 126a-h.

Each signal of the plurality of signals received by the secondary device 122 may include a dataset corresponding to the respective scanning device 126a-h. These datasets may generally include any suitable information associated with the respective scanning device 126a-h, and may more specifically include information such as: a model number, a serial number, a firmware version, a manufacturing date, a configuration name, a location, a signal strength indicator (e.g., RSSI value), a remaining battery charge value, a charging indicator (e.g., charging, not charging), a charging time indicator (e.g., time since last charged), a motion indicator (e.g., in-motion, static), a cradle docking status, a communication to a host/primary device (e.g., primary device 104), and/or any other suitable information or combinations thereof.

The secondary device 122 may analyze each respective dataset to determine a set of proximate devices from the plurality of proximate devices requiring substantially similar control. In the example environment 120, the secondary device 122 may receive signals (e.g., beacons) from each of scanning devices 126a-h and may analyze these signals to determine if any two or more of the scanning devices 126a-h require substantially similar control. As referenced herein, “substantially similar control” may indicate that the secondary device (e.g., device 122) may establish a similar and/or identical connection (e.g., instant direct connect, fast file transfer, etc.) with each of the proximate devices requiring the substantially similar control.

For example, the secondary device 122 may analyze the datasets from each scanning device 126a-h and determine that scanning devices 126a-f each fail to satisfy certain battery management thresholds and that scanning devices 126g-h do not require control. Based on this determination that the proximate scanning devices 126a-f require substantially similar control, the secondary device 122 may proceed to establish connections with the scanning devices 126a-f, as necessary. Of course, the secondary device 122 may not establish a two-way connection 128g-h with scanning devices 126g-h in these instances where the devices 126g-h do not require control.

Continuing the prior example, the secondary device 122 may analyze each respective dataset of scanning devices 126a-f to determine that scanning devices 126a and 126b violate a remaining battery charge threshold, scanning devices 126c and 126d violate a charging time threshold, and that scanning devices 126e and 126f violate a charging placement threshold. Accordingly, the secondary device 122 may substantially simultaneously establish a respective secondary connection 128a-f to each scanning device 126a-f, and may transmit a control instruction to each scanning device 126a-f across the respective secondary connections 128a-f to generate an alert at each scanning device 126a-f.

Namely, the secondary device 122 may establish an instant direction connection 128a-128f with each of scanning devices 126a-f to transmit a control instruction to each device 126a-f to, for example, emit some form of feedback (e.g., audible sound, visible light, vibration, etc.) so that the devices 126a-f may be located and analyzed to resolve the respective battery management issues. Additionally, or alternatively, the secondary device 122 may display or otherwise communicate an alert to the user currently utilizing the secondary device 122 that the scanning devices 126a-f have violated the respective battery management thresholds (e.g., remaining battery charge threshold, charging time threshold, charging placement threshold). The secondary device 122 may also transmit an alert to a backend server indicating that each of the scanning devices 126a-f has violated a respective battery management threshold, and the backend server may record/store this alert as part of a record for the scanning devices 126a-f.

As another example, the secondary device 122 may store and/or otherwise access a time threshold configured to represent a closing time for the warehouse, retail location, and/or other environment represented by the work environment 130. The secondary device 122 may determine that time threshold is exceeded and/or otherwise violated when the current time is later than the time threshold, and as a result, the secondary device 122 may initiate a sweeping scan of any/all proximate scanning devices (e.g., scanning devices 126a-h) to determine whether any scanning devices 126a-h are not charging and/or otherwise violate a battery management threshold. The scanning devices 126a-h may transmit signals that are received by the secondary device 122, and the device 122 may determine that scanning device 126g is not currently charging. Accordingly, the secondary device 122 may establish the secondary connection 128g with the scanning device 126g to transmit a control instruction to the device 126g across the secondary connection 128g, thereby causing the scanning device 126g to generate/output an alert that the scanning device 126g is not charging at closing time.

Thus, as described in the prior examples, the secondary device 122 may also transmit a control instruction to each proximate device of the set of proximate devices (e.g., scanning devices 126a-h) across the respective secondary connections (e.g., secondary connections 128a-h) to control each proximate device of the set of proximate devices. As mentioned, each of the secondary connections 128a-h may be any suitable connection (e.g., instant direct connection via BLE, fast file transfer, etc.) having any suitable data packet size limits, transmission rates, bandwidth limitations, and/or other suitable parameters or combinations thereof. The secondary device 122 may also transmit control instructions across these secondary connections to perform any suitable control functions. For example, the control instructions may cause and/or otherwise result in querying battery/charging information of scanning devices 126a-h, activating a function of a scanning devices 126a-h, and/or any other suitable functions or combinations thereof.

It should be understood that the scanning devices (e.g., scanning devices 102, 126a-i) and secondary devices (e.g., secondary device 106, 122) described herein are for the purposes of discussion only. The techniques described herein may be used to simultaneously control, manage, and/or otherwise track any suitable number of scanning devices and/or other suitable devices, and such devices may connect and/or otherwise transmit beacon signals to any suitable number of secondary devices and/or other suitable devices (e.g., Internet of Things (IoT) bridge).

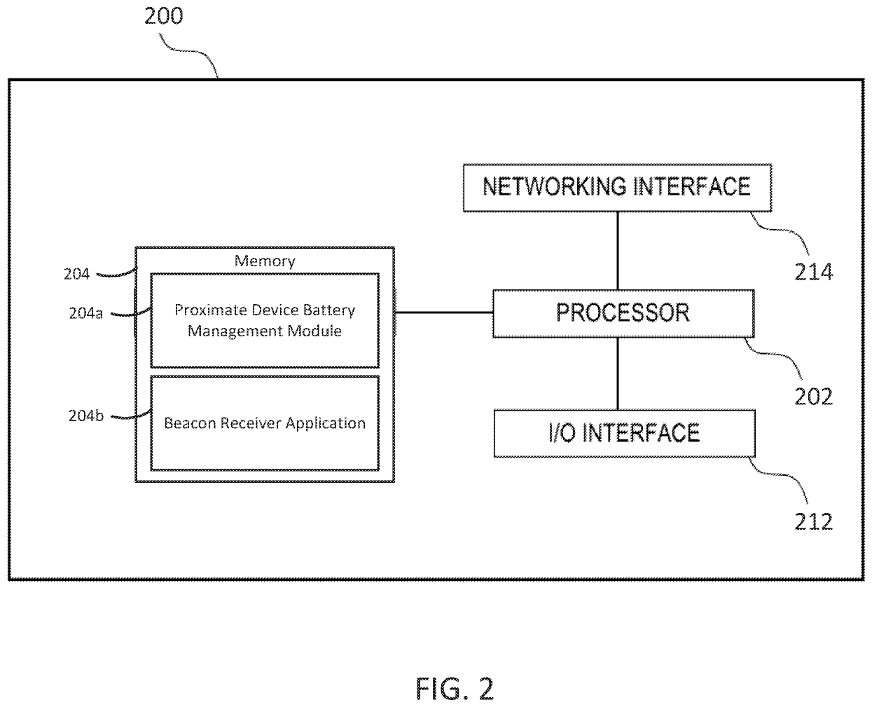

FIG. 2 is a block diagram representative of an example logic circuit capable of implementing, for example, one or more components of the secondary device 106 of FIG. 1. The example logic circuit of FIG. 2 is a processing platform 200 capable of executing instructions to, for example, implement operations of the example methods described herein, as may be represented by the flowcharts of the drawings that accompany this description. Other example logic circuits capable of, for example, implementing operations of the example methods described herein include field programmable gate arrays (FPGAs) and application specific integrated circuits (ASICs).

The example processing platform 200 of FIG. 2 includes a processor 202 such as, for example, one or more microprocessors, controllers, and/or any suitable type of processor. The example processing platform 200 of FIG. 2 includes memory (e.g., volatile memory, non-volatile memory) 204 accessible by the processor 202 (e.g., via a memory controller). The example processor 202 interacts with the memory 204 to obtain, for example, machine-readable instructions stored in the memory 204 corresponding to, for example, the operations represented by the flowcharts of this disclosure. The memory 204 also includes a proximate device battery management module 204a and a beacon receiver application 204b that are accessible by the example processor 202.

The proximate device battery management module 204a may comprise or represent rule-based instructions, an artificial intelligence (AI) and/or machine learning-based model(s), and/or any other suitable algorithm architecture or combination thereof configured to, for example, perform device control and battery management operations for a scanning device (e.g., scanning device 102). To illustrate, the example processor 202 may access the memory 204 to execute the proximate device battery management module 204a and determine whether a proximate device requires control and what control instruction to provide the proximate device. More generally, the proximate device battery management module 204a may include executable instructions configured to analyze a dataset included as part of a signal received from a proximate device and determine whether and how the proximate device requires control. After determining whether and how the proximate device requires control, the proximate device battery management module 204a may also generate and/or otherwise inform a control instruction configured to perform and/or otherwise cause the proximate device to perform the determined control.

The beacon receiver application 204b may comprise or represent rule-based instructions, an artificial intelligence (AI) and/or machine learning-based model(s), and/or any other suitable algorithm architecture or combination thereof configured to, for example, receive and interpret signals received from proximate devices. As an example, the beacon receiver application 204b may include executable instructions configured to interpret data packets structured in conformance with a BLE beaconing communication protocol and/or any other suitable communication protocol. To illustrate, the example processor 202 may access the memory 204 to execute the beacon receiver application 204b and interpret a BLE beacon signal received via the networking interface 214.

Additionally, or alternatively, machine-readable instructions corresponding to the example operations described herein may be stored on one or more removable media (e.g., a compact disc, a digital versatile disc, removable flash memory, etc.) that may be coupled to the processing platform 200 to provide access to the machine-readable instructions stored thereon.

The example processing platform 200 of FIG. 2 also includes a networking interface 214 to enable communication with other machines via, for example, one or more networks. The example networking interface 214 includes any suitable type of communication interface(s) (e.g., wired and/or wireless interfaces) configured to operate in accordance with any suitable protocol(s) (e.g., BLE, Wi-fi, Ethernet for wired communications and/or IEEE 802.11 for wireless communications). For example, the example processing platform 200 may be communicatively connected with a proximate device (e.g., scanning devices 102, 216a-h) through the networking interface 214, such that the platform 200 may transmit/receive data to/from the proximate device. Additionally, the processors 202 may execute instructions of the proximate device battery management module 204a and/or the beacon receiver application 204b stored in memory 204 to receive and interpret beacon signals and to transmit control instructions to proximate devices via the networking interface 214.

The example processing platform 200 of FIG. 2 also includes input/output (I/O) interfaces 212 to enable receipt of user input and communication of output data to the user. Such user input and communication may include, for example, any number of keyboards, mice, USB drives, optical drives, screens, touchscreens, etc. The I/O interfaces 212 may enable a user to input data, such as a desired geofence boundaries, configuration settings, battery charging/charge settings, which the processors 202 may use to determine control instructions for proximate devices, in accordance with instructions included as part of the proximate device battery management module 204a and/or the beacon receiver application 204b.

Of course, it should be appreciated that, while the various components of the example processing platform 200 (e.g., processors 202, memory 204, etc.) are illustrated in FIG. 2 as single components, the example processing platform 200 may include multiple of each of the components.

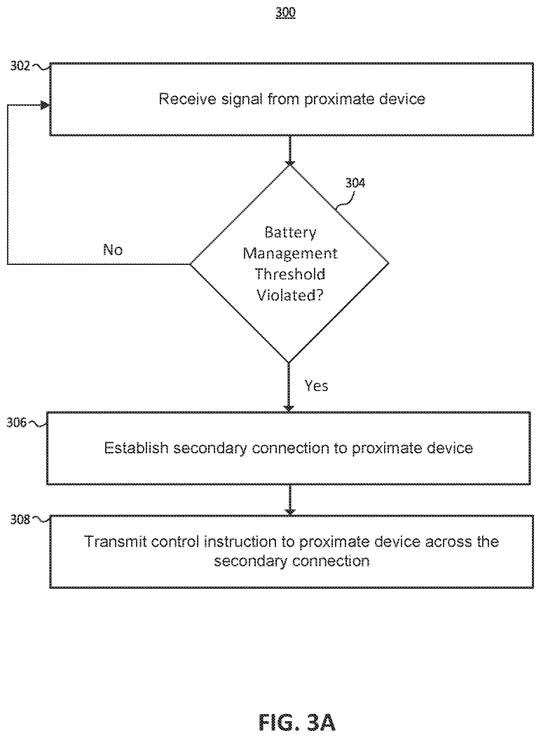

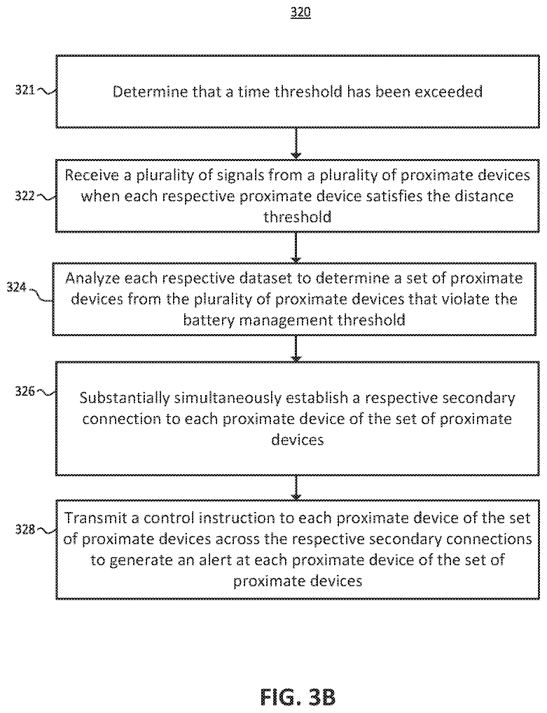

FIG. 3A is a flowchart representative of a method 300 for improving proximate device battery management, in accordance with embodiments described herein. It is to be understood that any of the steps of the method 300 may be performed by, for example, the secondary device 106, a proximate device (e.g., scanning device 102), and/or any other suitable components, components contained therein, and/or combinations thereof discussed herein.

At block 302, the method 300 includes receiving a signal from a proximate device when the proximate device satisfies a distance threshold. The signal may include a dataset corresponding to the proximate device, and the proximate device may have a primary connection to a primary device. The method 300 may further include analyzing the dataset to determine whether a battery management threshold of the proximate device is violated (block 304).

For example, the secondary device may analyze the dataset included as part of the transmitted signal (e.g., beacon) and determine that a remaining battery charge of the proximate device fails to satisfy a remaining battery charge threshold. The secondary device may thereby determine that the proximate device requires charging, such that the proximate device may also require control to cause the proximate device to, for example, turn off certain functions (e.g., indicia decoding components) to preserve the remaining battery charge, output an alert signal (e.g., flashing light, audio output, haptic feedback) indicating the low battery charge, and/or any other suitable control or combinations thereof.

If the secondary device determines that a battery management threshold is/has not been violated (NO branch of block 304), then the method 300 may include returning to block 302. The proximate device may continue emitting beacons and/or other suitable signals to be received by the secondary device, and the secondary device may continue receiving the signals while the secondary device is within receiving range of the signals. For example, the proximate device may periodically emit a signal/beacon every second, millisecond, several milliseconds/seconds, minute, several minutes, and/or any other suitable frequency.

However, if the secondary device determines that a battery management threshold is/has been violated (YES branch of block 304), the method 300 may include establishing a secondary connection to the proximate device (block 306). When the secondary device establishes the secondary connection to the proximate device, the method 300 may further include the secondary device transmitting the control instruction to the proximate device across the secondary connection (block 308). As previously mentioned, the control instruction may include and/or correspond to any suitable control function, such as querying battery/charging information of scanning devices, activating a function of a scanning devices, and/or any other suitable functions or combinations thereof.

Moreover, while the secondary device establishes and/or maintains the secondary connection with the proximate device, the proximate device may continue to transmit data across a primary connection to a primary device. These data transmissions across the primary connection may be or include, e.g., image data, decode data, and/or other suitable data or combinations thereof to a primary device (e.g., Point of Sale (POS), workstation, central server, etc.) configured to receive/process such data. In certain embodiments, the proximate device is configured to transmit a first dataset across the primary connection to the primary device, and at least a portion of the first dataset (e.g., image data, decode data) is not included in the signal (e.g., beacon) transmitted from the proximate device to the secondary device. Thus, the proximate device may maintain and/or transmit data across the primary connection to the primary device before, during, and/or after the secondary device establishes, maintains, and/or transmits control instructions across the secondary connection, as described in reference to the method 300.

In certain embodiments, the secondary connection may comprise an instant direct connection to the proximate device via a BLE protocol. Further, in some embodiments, the signal may be a BLE signal transmitted by the proximate device as a periodic beacon.

FIG. 3B is a flowchart representative of a method 320 for improving proximate device battery management, in accordance with embodiments described herein. It is to be understood that any of the steps of the method 320 may be performed by, for example, the secondary device 106, a proximate device (e.g., scanning device 102), and/or any other suitable components, components contained therein, and/or combinations thereof discussed herein.

At block 321, the method 320 may include determining that a time threshold has been exceeded. In certain embodiments, the time threshold may represent a time of day, and a secondary device, a central server, and/or any other suitable device may determine that a current time of day is later than the time threshold. For example, the time threshold may be 5:00 in the afternoon, and the current time of day may be 5:01 in the afternoon, such that the current time of day exceeds the time threshold. In this example, the suitable device may determine that the time threshold has been exceeded and may proceed to perform and/or otherwise cause the remaining actions of the method 320 to be performed.

At block 322, the method 320 may include receiving a plurality of signals from a plurality of proximate devices when each respective proximate device satisfies the distance threshold. Each respective signal of the plurality of signals may include a respective dataset corresponding to the respective proximate device. For example, a first proximate device, a second proximate device, and a third proximate device may each transmit signals received at a secondary device. The signal transmitted by the first proximate device may include a first respective dataset indicating that the first proximate device has 90% remaining battery life, has not been charged for thirty minutes, and that the first proximate device is not currently coupled with a charging cradle/station. The signal transmitted by the second proximate device may include a second respective dataset indicating that the second proximate device has 15% remaining battery life, has not been charged in over three hours, and that the second proximate device is not currently coupled with a charging cradle/station. The signal transmitted by the third proximate device may include a third respective dataset indicating that the third proximate device has 55% remaining battery life, is currently charging, and that the third proximate device is currently disposed in a charging cradle/station.

The method 320 may further include analyzing each respective dataset to determine a set of proximate devices from the plurality of proximate devices violate a battery management threshold (block 324). Continuing the prior example, the secondary device may determine that the third proximate device does not require control because the third proximate device is currently charging, but that the first proximate device and the second proximate device require control to charge the devices. Accordingly, the secondary device may determine that the first and second proximate devices require substantially similar control because both devices require control to resolve violation of a battery management threshold. In particular, both the first and second proximate devices may require control because both devices are not currently connected to a charging cradle/station after the time threshold is exceeded.

The method 320 may further include substantially simultaneously establishing a respective secondary connection to each proximate device of the set of proximate devices (block 326). Further in the prior example, the secondary device may substantially simultaneously establish an instant direct connection as a secondary connection to both the first proximate device and the second proximate device. Of course, the secondary device may not establish a secondary connection to the third proximate device, as the secondary device determined that the third proximate device does not currently require control.

The method 320 may further include transmitting a control instruction to each proximate device of the set of proximate devices across the respective secondary connections to generate an alert at each proximate device of the set of proximate devices (block 328). Continuing the prior example, the secondary device may transmit a control instruction to the first and second proximate devices across the secondary connections to the first and second proximate devices causing the first and/or second proximate devices to alert a user that the batteries require charging and/or to perform other functions that may preserve battery life (e.g., deactivating decoding functionality).

Of course, it is to be appreciated that the actions of any of the methods 300, 320 may be performed any suitable number of times, and that the actions described in reference to any of the methods 300, 320 may be performed any suitable number of times and in any suitable order.

### Additional Considerations

The above description refers to a block diagram of the accompanying drawings. Alternative implementations of the example represented by the block diagram includes one or more additional or alternative elements, processes and/or devices. Additionally, or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included scope within the of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A device for improving proximate device battery management, the device comprising:
one or more processors; and
one or more memories storing instructions thereon that, when executed by the one or more processors, are configured to cause the device to:
receive a signal from a proximate device when the proximate device satisfies a distance threshold, the signal including a dataset corresponding to the proximate device, and the proximate device having a primary connection to a primary device,
analyze the dataset to determine whether a battery management threshold of the proximate device is violated, and
in response to determining that the battery management threshold is violated, establish a secondary connection to the proximate device.

2. The device of claim 1, wherein the instructions, when executed by the one or more processors, further cause the device to:
transmit a control instruction to the proximate device across the secondary connection to generate an alert at the proximate device associated with violating the battery management threshold.

3. The device of claim 1, wherein the battery management threshold includes one or more of: (i) a remaining battery charge threshold of the proximate device, (ii) a charging time threshold of the proximate device, and (iii) a charging placement threshold of the proximate device.

4. The device of claim 1, wherein the secondary connection comprises an instant direct connection to the proximate device via a Bluetooth Low Energy (BLE) protocol.

5. The device of claim 1, wherein the instructions, when executed by the one or more processors, further cause the device to:
determine that a time threshold has been exceeded;
receive a plurality of signals from a plurality of proximate devices when each respective proximate device satisfies the distance threshold, each respective signal of the plurality of signals including a respective dataset corresponding to the respective proximate device;
analyze each respective dataset to determine a set of proximate devices from the plurality of proximate devices that violate the battery management threshold;
substantially simultaneously establish a respective secondary connection to each proximate device of the set of proximate devices; and
transmit a control instruction to each proximate device of the set of proximate devices across the respective secondary connections to generate an alert at each proximate device of the set of proximate devices.

6. The device of claim 1, wherein the signal is a BLE signal transmitted by the proximate device as a periodic beacon.

7. The device of claim 1, wherein the proximate device is configured to transmit a first dataset across the primary connection to the primary device, and at least a portion of the first dataset is not included in the signal transmitted from the proximate device.

8. A computer-implemented method for improving proximate device battery management, the method comprising:
receiving a signal from a proximate device when the proximate device satisfies a distance threshold, the signal including a dataset corresponding to the proximate device, and the proximate device having a primary connection to a primary device;
analyzing the dataset to determine whether a battery management threshold of the proximate device is violated; and
in response to determining that the battery management threshold is violated, establishing a secondary connection to the proximate device.

9. The computer-implemented method of claim 8, further comprising:
transmitting a control instruction to the proximate device across the secondary connection to generate an alert at the proximate device associated with violating the battery management threshold.

10. The computer-implemented method of claim 8, wherein the battery management threshold includes one or more of: (i) a remaining battery charge threshold of the proximate device, (ii) a charging time threshold of the proximate device, and (iii) a charging placement threshold of the proximate device.

11. The computer-implemented method of claim 8, wherein the secondary connection comprises an instant direct connection to the proximate device via a BLE protocol.

12. The computer-implemented method of claim 8, further comprising:
determining that a time threshold has been exceeded;
receiving a plurality of signals from a plurality of proximate devices when each respective proximate device satisfies the distance threshold, each respective signal of the plurality of signals including a respective dataset corresponding to the respective proximate device;
analyzing each respective dataset to determine a set of proximate devices from the plurality of proximate devices that violate the battery management threshold;
substantially simultaneously establishing a respective secondary connection to each proximate device of the set of proximate devices; and
transmitting a control instruction to each proximate device of the set of proximate devices across the respective secondary connections to generate an alert at each proximate device of the set of proximate devices.

13. The computer-implemented method of claim 8, wherein the signal is a BLE signal transmitted by the proximate device as a periodic beacon, the proximate device is configured to transmit a first dataset across the primary connection to the primary device, and at least a portion of the first dataset is not included in the signal transmitted from the proximate device.

14. A tangible machine-readable medium comprising instructions for improving proximate device battery management that, when executed, cause a machine to at least:
receive a signal from a proximate device when the proximate device satisfies a distance threshold, the signal including a dataset corresponding to the proximate device, and the proximate device having a primary connection to a primary device;
analyze the dataset to determine whether a battery management threshold of the proximate device is violated; and
in response to determining that the battery management threshold is violated, establish a secondary connection to the proximate device.

15. The tangible machine-readable medium of claim 14, wherein the instructions, when executed, further cause the machine to at least:
transmit a control instruction to the proximate device across the secondary connection to generate an alert at the proximate device associated with violating the battery management threshold.

16. The tangible machine-readable medium of claim 14, wherein the battery management threshold includes one or more of: (i) a remaining battery charge threshold of the proximate device, (ii) a charging time threshold of the proximate device, and (iii) a charging placement threshold of the proximate device.

17. The tangible machine-readable medium of claim 14, wherein the secondary connection comprises an instant direct connection to the proximate device via a BLE protocol.

18. The tangible machine-readable medium of claim 14, wherein the instructions, when executed, further cause the machine to at least:
determine that a time threshold has been exceeded;
receive a plurality of signals from a plurality of proximate devices when each respective proximate device satisfies the distance threshold, each respective signal of the plurality of signals including a respective dataset corresponding to the respective proximate device;
analyze each respective dataset to determine a set of proximate devices from the plurality of proximate devices that violate the battery management threshold;
substantially simultaneously establish a respective secondary connection to each proximate device of the set of proximate devices; and
transmit a control instruction to each proximate device of the set of proximate devices across the respective secondary connections to generate an alert at each proximate device of the set of proximate devices.

19. The tangible machine-readable medium of claim 14, wherein the signal is a BLE signal transmitted by the proximate device as a periodic beacon.

20. The tangible machine-readable medium of claim 14, wherein the proximate device is configured to transmit a first dataset across the primary connection to the primary device, and at least a portion of the first dataset is not included in the signal transmitted from the proximate device.
